(19) United States
(12) Patent Application Publication
(10) Pub. No.: US 2023/0004990 A1
(43) Pub. Date: Jan. 5, 2023

(54) METHOD OF SECURING A PAYMENT CARD TRANSACTION

(71) Applicant: DUCKPOND TECHNOLOGIES, INC., BATON ROUGE, LA (US)

(72) Inventor: DARTANYON ANTWAUN WILLIAMS, DATON ROUGE, LA (US)

(73) Assignee: DUCKPOND TECHNOLOGIES, INC., BATON ROUGE, LA (US)

(21) Appl. No.: 17/939,310

(22) Filed: Sep. 7, 2022

Related U.S. Application Data
(63) Continuation-in-part of application No. PCT/US21/21785, filed on Mar. 10, 2021.
Application No. PCT/US21/21785 is a continuation of application No. PCT/US21/21774, filed on Mar. 10, 2021.
(60) Provisional application No. 62/987,389, filed on Mar. 10, 2020.
(60) Provisional application No. 62/987,402, filed on Mar. 10, 2020.

(51) Int. Cl. G06Q 30/00; H04L 9/06; G06Q 40/02

(52) U.S. Cl. CPC G06Q 30/018; H04L 9/0662; G06Q 40/02; H04L 2209/56

(57) ABSTRACT

A system for preventing or inhibiting Payment Card fraud. When a Payment Card transaction is initiated, the card network conveys cardholder identifying information to the bank that issued the Payment Card. The issuing bank generate a random, one time data code (OTDC) upon receipt of cardholder identifying information. Alternatively, the cardholder may request an OTDC, by directly messaging the issuing bank or via an automated communication between the cardholder's mobile device and the issuing bank. The issuing bank then sends the cardholder an OTDC, preferably via an encrypted, secured transmission. The cardholder provides the OTDC to the merchant. The OTDC is part of the issuing bank's transaction approval criteria. The transaction should not be approved unless the merchant provides the OTDC to the issuing bank. The OTDC will only work for the transaction in question, and it will preferably expire shortly after its generation, if it remains unused.

### PRIORITY CLAIM

This application is a continuation of and claims benefit to U.S. PCT application PCT/US2021/021774 which was filed on Mar. 10, 2021, and which claimed benefit to U.S. provisional patent application No. 62/987,402, filed on Mar. 10, 2020, both of which are hereby incorporated by reference in their entirety. This application is also a continuation-in-part of and claims benefit to U.S. PCT application PCT/US2021/021785 which was filed on Mar. 10, 2021, and which claimed benefit to U.S. provisional patent application No. 62/987,389, filed on Mar. 10, 2020, both of which are hereby incorporated by reference in their entirety.

### BACKGROUND OF THE INVENTION

### Field of the Invention

The invention pertains to secure electronic purchasing in general and secure credit and debit card purchasing in particular.

### Prior Art

Credit card, debit card, and prepaid card (collectively, “Payment Card”) fraud is a problem of global proportions. In 2018, global Payment Card fraud exceeded $27 Billion (USD). Numerous efforts exist to stem fraud in this arena. One is the EMV or “Chip and Pin” protocol. This is a relatively effective security system in which a computer chip is embedded in the Payment Card. When the Payment Card is placed in a card reader, the system can verify that the Payment Card is authentic by reading information on the chip. This makes it much more difficult to create a useable counterfeit Payment Card. Unfortunately, the result has been to push Payment Card fraud online. Between 2015 and 2016, card-present fraud—fraud where a fraudulent card was physically presented to a merchant—fell in the U.S. from $3.6 Billion (USD) to $2.9 Billion (USD) annually. In the same time frame, card-not-present fraud jumped from $3.4 Billion (USD) to 4.57 Billion (USD). By 2020, card-not-present fraud was over 80 percent more common than card-present fraud.

One way that Payment Card companies attempt to combat online and other card-not-present fraud is with single use account numbers. The account number on a Payment Card typically contains between 13 and 19 digits and most commonly 15 or 16 digits. An account number being compromised is one source of Payment Card fraud. Consumers give the account number to a salesperson over a phone line or enter it into a computer system in the course of making a purchase. This creates opportunities for the account number to become compromised by a person working for the merchant or by a person who has hacked into the merchant's computer system. To avoid this risk, consumers can request a single-use Payment Card number. The Payment Card company will issue a single use 13-19 digit number that can be used only once. If the number is compromised, it will not matter because the number cannot be used again. This method is very effective in combating fraud. However, it is highly inefficient. Telephone and especially online commerce has increased rapidly over the past decade and exploded over the pandemic year of 2020. It is not practical for consumers to request a single use account number every time they want to use their Payment Card to make an online purchase. The limitation of liability policies under which consumers are only responsible for up to $50 (USD) in fraudulent charges provides little incentive for consumers to go to the effort necessary to obtain single use numbers for every transaction. Additionally, the approach does not work at all for card-present transactions, when the physical Payment Card, with the actual card number, is usually presented. Moreover, the effort required to obtain a single use number with every transaction acts as an impediment to the use of the Payment Card by the consumer. This is contrary to the interest of the Payment Card issuers, who want to maximize the use of their cards, not impede them.

Another approach to fraud prevention is transaction monitoring. Card companies keep watch on the cardholders' purchase behavior. If a purchase is made with the Card number that appears out of line with the cardholder's ordinary purchasing patterns, whether in terms of location for card-present transactions or in terms of amount or the nature of the purchase for card-not-present transactions, the Card company may put a hold on the transaction, refusing to allow the transaction to proceed until the card holder can be reached. The card may be inactivated as well, pending verification of the transaction by the consumer. The effectiveness of this approach is open to debate, as less brazen criminals are unlikely to trigger the system. Additionally, false positives under this approach are extremely undesirable from the perspective of the Payment Card company, as they inhibit use of the Card by the consumer.

When fraud is detected, the Payment Card companies will cancel the card number and issue a new Payment Card with a new account number to the consumer. In addition to the cost of replacement, this adversely affects the Payment Card issuer because it prevents the consumer from using the Payment Card while it is being replaced. Anything that inhibits the cardholders' use of their Payment Cards is contrary to the interests of Payment Card issuers. Accordingly, a system and method of preventing Payment Card fraud is desired.

### OBJECTS OF THE INVENTION

It is an object of the invention to prevent or inhibit Payment Card fraud.

It is another object of the invention to prevent or inhibit card-not-present Payment Card fraud.

It is still another object of the invention to prevent or inhibit card-present Payment Card fraud.

It is yet another object of the invention to prevent or inhibit Payment Card fraud without inhibiting the ability of consumers to use their Payment Cards.

It is still another object of the invention to prevent or inhibit Payment Card fraud without requiring any additional affirmative steps from consumers during a Payment Card transaction.

It is yet another object of the invention to minimize the amount of time Payment Cards must be inactivated because of suspected or actual fraud.

### SUMMARY OF THE INVENTION

A system for preventing or inhibiting Payment Card fraud is disclosed. When a cardholder attempts to use a Payment Card, the network will convey cardholder identifying information to the bank that issued the Payment Card. The issuing bank will generate a random, one time data code (OTDC) upon receipt of cardholder identifying information and an indication that the cardholder is attempting to use the card. Alternatively, the cardholder may request an OTDC from the issuing bank, either by directly messaging the issuing bank or via an automated communication between the cardholder's mobile device and the issuing bank. The issuing bank will transmit the OTDC to the cardholder, which transmission may be encrypted and secured. Provision of an OTDC is part of the issuing bank's transaction approval criteria. The cardholder will provide the OTDC to the merchant.

If the merchant cannot provide an OTDC matching the OTDC just generated by the issuing bank, the transaction should not be approved. The OTDC will only work for the transaction in question, and it will preferably expire shortly after its generation, if it remains unused.

### BRIEF DESCRIPTION OF THE DRAWINGS

FIG. 1A is a front view of a exemplary Payment Card.

FIG. 1B is a rear view of an exemplary Payment Card.

FIG. 2 is a flow chart illustrating the steps of a preferred embodiment of the fraud prevention system disclosed herein.

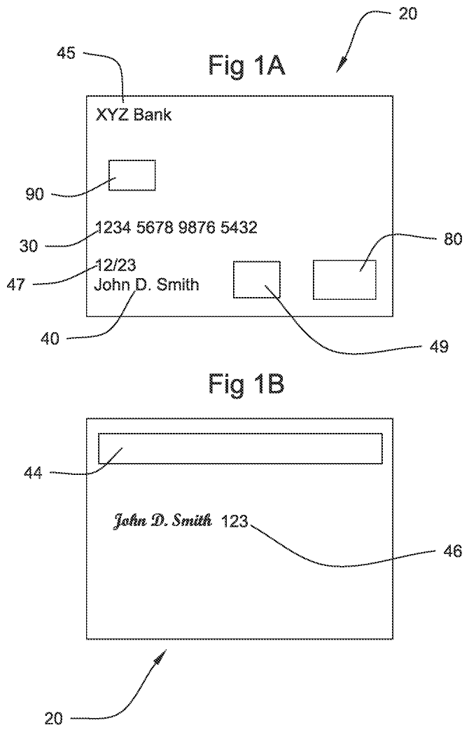

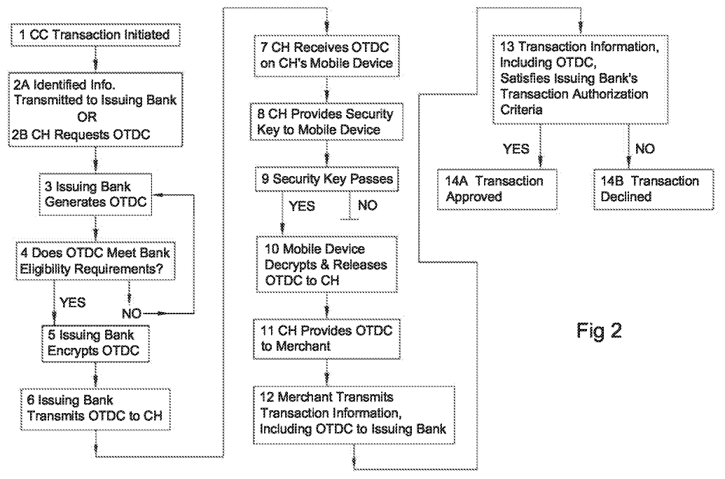

### DETAILED DESCRIPTION OF THE BEST MODE

In a standard Payment Card transaction, the transaction is initiated 1 when a cardholder 40 presents his or her Payment Card 20 or card number 30 to a merchant, such as Wal-Mart™, a service station, Amazon™, or a local plumber. The merchant transmits (at a minimum) 2A the card number 30 (or a code corresponding to the card number 30) and the transaction amount to the merchant bank or its processor(s)(collectively, the “merchant bank”), which transmits the card number 30 (or a code) to the issuing bank or its processor(s)(collectively, the “issuing bank” or “issuer bank” 45) via the appropriate card network 80, which are commonly indicated on the face of the Payment Card 20. The most common card networks are Banknet™ which processes MasterCard™ transactions and VisaNet™ which processes Visa™ transactions. Common issuing banks 45 include Chase™, Capital One™, Bank of America™, etc. American Express™ and Discover™ have their own networks; however, in addition to being networks American Express™ and Discover™ are also the issuing bank 45, serving dual roles in their systems. However, conventional banking facilities are not necessary for a bank to issue payment cards 20. The issuing bank 45 may be a digital bank. Criteria to be an issuing bank 45 will typically be determined by the card network 80.

Historically, the cardholder information was contained in a magnetic strip 44 on the back of the Payment Card 20, though most modern Payment Cards 20 contain this information in the EMV chip 90 and/or contactless chip 49, which are usually provided in addition to the magnetic strip 44. The foregoing communication typically takes place over a telecommunication system such as the telephone system or the Internet.

The issuing bank 45 determines 4 whether the transaction meets its criteria—the “transaction approval criteria”—and issues a code approving 14A or declining 14B the transaction, which is transmitted back through the card network to the merchant. At this point, the transaction is authorized (or not).

The transaction approval criteria of issuing banks may vary substantially. Most check to ensure that the transaction will not exceed the credit limit or funds available associated with the Payment Card 20, that the cardholder 40 is in good standing, and that the Payment Card 20 is not expired. For card-present transactions, the issuing bank 45 may require the cardholder 40 to enter a personal identification number (PIN) or to provide a signature. When the Payment Card 20 includes a chip 90, the EVC information from the chip 90 will typically be required. For card-not-present transactions, many issuing banks 45 require the cardholder's billing address to be provided to the merchant. Many issuing banks 45 also require the merchant to obtain the card verification value (CVV) 46 from the cardholder 40. This is, typically, a three or four digit code on the back of many Payment Cards 20. If the transaction approval information provided by the cardholder 40 does not match or meet the issuer's transaction approval criteria, the transaction should not be authorized. Many issuing banks 45 also put a limit on the number of times a particular card number 30 may be attempted to be used without passing the transaction approval criteria, essentially “locking” the card number 30 for some period of time if too many failed attempts are made. How many are too many may vary, but 3 to 5 and most preferably 3 failed attempts before locking the card number 30 is an appropriate number to avoid brute force attacks.

In a preferred embodiment of the invention, an additional security measure is provided. The issuing bank's transaction authorization system, typically a backend server, will generate 3 a one time data code (OTDC), sometimes referred to as a card-not-present transaction number (CNPN), though it may be used in card-present and card-not-present transactions.

In one embodiment, initiation of the transaction 1 will cause the cardholder's Payment Card number 30 or other cardholder identifying information to be transmitted 2A to the issuing bank 45. (As discussed above, the merchant transmits information to the merchant's bank or processor(s) which transmit information to the issuing bank 45 or its processor via the card network. Those of skill in the art will understand the channels of communication. Accordingly, these are not repeated for each communication between the merchant and the issuing bank 45.)

Receipt of sufficient information by the issuing bank 45 to (a) identify the cardholder 40 and (b) indicate that the cardholder 40 is attempting to conduct a transaction using the Payment Card 20 will trigger the issuing bank 45 to generate 3 an OTDC.

In another embodiment, as addressed in more detail below, the cardholder 40 may initiate the generation of an OTDC, by sending the issuing bank 45 a request 2B for an OTDC.

Whether the OTDC is generated 3 automatically by the issuing bank 45 in response to information indicating that a transaction has been initiated 2A or at the request 2B of the cardholder 40, generation of an OTDC may be done by a random number generator. The random number generator may be a true random number generator, a pseudo-random number generator, or a cryptographically secure pseudo-random number generator. All of these are intended to be encompassed within the phrase, “random number generator.” There are many different computer based random number generators known and available to those of skill in the art.

The OTDC may be as many digits as the issuing bank 45 desires. Typically, the OTDC will be three to five digits. If letters or special characters are desired, they may be included in the OTDC.

As the name implies, a one time data code is intended to be used once. The issuing bank's computer system may check 4 the OTDC to ensure that it hasn't been utilized by the cardholder 40 or with the cardholder's Payment Card number 30 before. If the randomly generated OTDC is not unique, or if it does not meet some other criteria of the issuing bank 45, the ineligible OTDC will be discarded and a new OTDC will be generated before the OTDC is transmitted 6 by the issuing bank 45.

In some embodiments, the list of OTDC's ineligible for use with a particular Payment Card 20 will reset. Generally speaking, the shorter the OTDC, the more likely a reset will be required to prevent the system from running out of eligible OTDC's. The list of ineligible OTDC's may reset once a set passage of time has expired—every thirty or ninety days for example. The list could reset every time Payment Card 20 expires and a new Payment Card 20 is issued. The list could reset every time a new card number 30 is issued. The list of ineligible OTDC's may never reset. A reset may be unnecessary when the OTDC is five of more digits in length. Finally, a list of ineligible OTDC's is a security option, not a requirement. Because the OTDC is randomly generated, the odds of a new, randomly generated OTDC matching an earlier OTDC will be negligible—roughly 1/1000 for a three digit OTDC. Knowing one or even several OTDC's previously used with a particular payment card number 30 would be very unlikely to enable a third party to use the credit payment number 30 to make an unauthorized purchase even if the OTDC's were reused because a previously used OTDC is very unlikely to match the OTDC generated for the transaction in question. When the issuing bank 45 locks card numbers 30 for excessive failed attempts to pass the transaction authorization criteria, the already small risk of a previously used OTDC being successfully used to fraudulently obtain authorization for a particular transaction is further reduced.

Once the OTDC has been generated 3 and found to meet the issuing bank's criteria 4, the issuing bank 45 will transmit 6 the OTDC to the cardholder 40. It will be appreciated that generation of the OTDC and any screening of the selection will be performed by the issuing bank's computer system. Transmission of the OTDC to the cardholder 40 may be via a variety of means. Transmission of the OTDC to the cardholder 40 may be done by email or text, telephone call, push notification, or any other communication pathway. The issuing bank 45 may encrypt 5 the message containing the OTDC and send the message to the cardholder 40 in a format that may require a security key from the cardholder 40 to open. The preferred embodiment will preferably use asymmetric encryption to secure the OTDC, though many commercially available encryption systems are available. Examples of security keys that may be used to authorize opening of the message include passwords and biometric keys such as a match from a fingerprint reader, facial recognition software, iris recognition software, voice recognition software or combinations of the foregoing.

Frequently, the transmission 6 of the OTDC to the cardholder 40 will be received 7 by the cardholder's personal portable computing device such as a tablet, netbook, or cellphone, which may be a smartphone (collectively, a “mobile device”) or by a mobile device otherwise associated with the cardholder 40. In these uses, the mobile device's security may provide sufficient security. For example, if the cardholder's mobile device requires a password or a biometric key to open the mobile device, this may be sufficient to allow one using the mobile device to open or access the message containing the OTDC. Alternatively, the message containing the OTDC may require similar, independent security to open. Finally, the additional security is an option, not a requirement of the system. There is no requirement that any security be in place to open the message. If the issuing bank 45 and/or cardholder 40 so choose, the message containing the OTDC may be transmitted without additional security.

In another embodiment, the cardholder 40 may use his or her mobile device as a digital version of the Payment Card 20. In this embodiment, a downloadable mobile application designed to be compatible across mobile operating systems on mobile devices, such as iOS and Android operating systems and other like systems will be installed on the cardholder's mobile device. A connected network may provide data storage, computing functionality, application security, and similar functionality. The cardholder 40 will enter identification information to create an account. The cardholder's identification information may include, without being limited to these items, some or all of the following: the cardholder's name; the cardholder's social security number; the cardholder's date of birth; the cardholder's home or billing address, and the cardholder's driver's license or other state or federally issued identification number. The cardholder 40 may also enter a payment card number 30, the expiration date 47 of the Payment Card 20, and the CVV number 46 for the Payment Card 20. In this embodiment, the payment card number 30 and other cardholder identifying information will be stored on the mobile device or in a remote, typically cloud-based, data storage location. Much of the information above may correspond to the information typically found in computer chips 90 embedded in Payment Cards 20 utilizing EMV protocol. At a minimum, the information in or associated with the mobile device will be information sufficient to identify cardholder 40 and the account number 30, and information sufficient to identify the issuing bank 45. This allows the cardholder 40 to make contactless purchases—that is, a purchase from a merchant without presenting a physical Payment Card 20 to the merchant.

Some Payment Cards 20 include contactless chips 49. These are chips embedded in the card, usually distinct from the security chip 90, that contain the information discussed in the context of using the mobile device as the Payment Card 20. Contactless chips 49 utilize radio-frequency identification (RFID) technology. The merchant's card reader powers the contactless chip in the card which then emits a signal containing information sufficient to identify the cardholder 40 and the issuing bank 45. This information is then transmitted to the issuing bank 45 along with the other transaction information.

When contactless chips 49 and/or EMV chip 90 are present, physical payment cards 20 need not have the payment card number 30 printed on their face or, for card-present transactions, printed on them at all.

When the cardholder's mobile device includes a downloadable mobile application disclosed herein, the communication to the cardholder 40 of the OTDC may be performed as an in-application communication. The security measures discussed above may, optionally, be utilized to control access to any in-application communications, including messages containing the OTDC. The cardholder 40 will provide 8 the appropriate security key to allow the message containing the OTDC to be opened.

When the communication to the cardholder 40 of the OTDC is encrypted, the cardholder 40 will have a decryption key to allow the cardholder's mobile device to decrypt 10 the communication. The decryption key may be contained on the cardholder's mobile device and/or contained within the downloadable mobile application on the mobile device. Updated decryption key(s) may be provided by the issuing bank 45 from time-to-time, via the same communication methods used to transmit the OTDC.

In one embodiment, the issuing bank's computer system may generate 3 the OTDC upon receipt of information indicating that a transaction has been initiated and identifying the card holder 2A. As used herein, a transaction is initiated when the cardholder 40 does anything to attempt to effect a purchase from a merchant and provides information via the merchant or the merchant's computer network sufficient to allow the issuing bank 45 to identify the cardholder 40.

Alternatively, the cardholder's mobile device could contact the issuing bank 45 directly, via the Internet or other telecommunication network, to alert the issuing bank 45 that an OTDC needs to be generated. This request 2B may occur automatically when the cardholder 40 commences use of the mobile device as a Payment Card 20, or the cardholder 40 may use the mobile device to contact the issuing bank 45 to request 2B an OTDC prior to using the mobile device or a physical Payment Card 20 to make a purchase or prior to initiating a card-not-present transaction online or over the phone.

Regardless of what prompts the OTDC to be generated 3, it is transmitted 6 to the cardholder 40 and added to the issuing bank's transaction approval criteria. If the OTDC is not provided to the issuing bank 45 by the merchant or the merchant's system, the transaction should not be approved.

In some embodiments, the OTDC may have an expiration date or time. The OTDC may not work unless it is used within a set number of hours or minutes from when it is generated. When the OTDC is generated in the course of an initiated transaction, the merchant may be identified to the issuing bank 45. In this embodiment, the OTDC may be limited to use in a transactions with the identified merchant.

In some embodiments, the system may be configured to notify the cardholder 40 if an attempt was made to use the cardholder's Payment Card number 30 that did not meet the issuing bank's transaction approval criteria. This notification may include where the attempted transaction took place and what time the attempted transaction occurred. The system may provide the cardholder 40 with details as to why the transaction approval criteria were not satisfied, such as failure to input a correct OTDC. The disclosed system may automatically generate a communication, populate the communication with information about the failed transaction attempt, and send the communication to the cardholder 40. In one embodiment, the disclosed system may send the communication to the cardholder 40 via email, text message, telephone call, push notification, or any other communication pathway, and the communication may be provided as an in-application communication.

In some embodiments, validation information may be provided to the cardholder 40. This could include date, time, merchant location, and amount. This may be provided to the cardholder 40 with text, email, push notification, in-application communication or any other means of communication. The validation information may also be maintained in a registry by the issuing bank 45 in a format accessible to the cardholder 40.

In operation, a cardholder 40 will initiate 1 a purchase either in the physical presence of the merchant, online, or over the telephone. For a card-present or otherwise cardholder-present transaction, transmission 2A to the issuing bank 45 of the payment card number 30 or other cardholder identifying information will prompt the issuing bank 45 to generate 3 an OTDC. The issuing bank 45 will transmit 6 the OTDC to the cardholder 40, most typically by transmitting 6 the OTDC to the cardholder's mobile device. The mobile device may prompt the cardholder 40 to provide a security key, which if provided will allow the mobile device to decrypt, display, and/or otherwise release 10 the OTDC. The cardholder 40 will then enter or otherwise provide 11 the OTDC to the merchant. For in-store transactions or transactions where the merchant and cardholder 40 are both physically present, this may be done on a keypad as the PIN stage of the transaction or in addition to the PIN stage of the transaction. For online or telephonic transactions, this may be done as the CVV stage of the transaction or in addition to the CVV stage of the transaction. For touchless transactions, the mobile device may provide the OTDC directly to the merchant's terminal. The merchant will then transmit 12 the OTDC, and any other transaction information not already provided, to the issuing bank 45. If the OTDC matches the number generated by the issuing bank 45, and the issuing bank's other transaction authorization criteria are met, 13 the transaction will be authorized 14A. However, if the OTDC provided to the merchant 4 does not match the OTDC generated by the issuing bank 45, or if the bank's other authorization criteria are not met, the transaction should not be authorized 14B.

The OTDC may be used in ATM transactions as well. For purposes of this application, the term merchant includes an ATM. Most ATM (automated teller machine) transaction utilize card and PIN security. In an embodiment of the invention, placing the Payment Card 20 into the ATM or, in any ATM's that utilize touchless technology, scanning the cardholder information into the ATM will cause a signal to be transmitted to the issuing bank 45, triggering the generation of an OTDC which will then be transmitted to the cardholder's mobile device. The cardholder 40 will provide the OTDC to the ATM in lieu of or in addition to the PIN, at which point the ATM transaction will be allowed to proceed. If the OTDC is not provided to the ATM, the ATM transaction should not be authorized.

Although the issuing bank 45 (or its processors) are responsible for generating the OTDC in most of the embodiments disclosed herein, those of skill in the art will appreciate that an intermediary could be responsible for generating the OTDC. For example, the card network 80 could generate the OTDC and transmit it to both the cardholder 40 and the issuing bank 45. From there, the process would be the same. The cardholder 40 would transmit the OTDC to the merchant who would then transmit the OTDC to the issuing bank 45. The transaction would not be approved unless the OTDC provided to the issuing bank 45 by the merchant matched the OTDC generated by the intermediary. The identity of the intermediary is not important, except that the intermediary should not be the merchant, nor should the intermediary ever convey the OTDC to the merchant.

The advantages of the present security system are multi-fold. If the cardholder's payment card number 30 is compromised, it cannot be used to make a purchase without the OTDC. Acquiring the OTDC will not allow a third party to make a purchase without the payment card number 30 and other elements of the issuing bank's transaction approval criteria. Even acquiring the OTDC and the payment card number 30 will not allow a third party to make additional purchases on the Payment Card 20. The OTDC is a single use code. It is generated for the transaction in question and good for that transaction only. Having the payment card number 30 and an old OTDC will not allow a third party to make a purchase. A third party must have both the payment card number 30 and the current OTDC to make a purchase using the Payment Card 20. Obtaining one without the other is useless.

Although the preferred embodiments have been described herein, those skilled in the art to which the present invention pertains will appreciate that modifications, changes, and improvements may be made without departing from the spirit of the invention defined by the following claims.

I claim:

1. A method of securing a Payment Card transaction conducted, at least in part, over a telecommunication network among a cardholder, an issuing bank, and a merchant, wherein the method comprises:
transmitting sufficient information to the issuing bank over the telecommunication network to identify a cardholder;
generating a one time data code;
transmitting the one time data code to the cardholder over the telecommunication network;
conveying the one time data code from the cardholder to the merchant;
transmitting the one time data code from the merchant to the issuing bank over the telecommunication network;
checking if the one time data code transmitted to the issuing bank by the merchant matches the generated one time data code; and
declining to authorize the transaction unless the one time data code transmitted to the issuing bank by the merchant matches the generated one time data code.

2. The method of securing a Payment Card transaction according to claim 1 wherein the one time data code is generated using a random number generator.

3. The method of securing a Payment Card transaction according to claim 2 wherein the issuing bank generates the one time data code.

4. The method of securing a Payment Card transaction according to claim 2 wherein the one time data code is generated after the cardholder initiates the transaction with the merchant.

5. The method of securing a Payment Card transaction according to claim 2 wherein the one time data code is encrypted prior to transmitting the one time data code to the cardholder.

6. The method of securing a Payment Card transaction according to claim 5 wherein the one time data code is transmitted to the cardholder by transmitting the one time data code over the telecommunication network to a mobile device associated with the cardholder.

7. The method of securing a Payment Card transaction according to claim 6 wherein the one time data code is transmitted to the cardholder over the telecommunication network via a communication method selected from the group consisting of email, text message, telephone call, push notification, and combinations thereof.

8. The method of securing a Payment Card transaction according to claim 6 further comprising requiring a security key to be provided to the mobile device before the one time data code is released to the cardholder.

9. The method of securing a Payment Card transaction according to claim 8 wherein the security key is selected from the group consisting of a password and a biometric key and combinations thereof.

10. The method of securing a Payment Card transaction according to claim 9 wherein the biometric key is selected from the group consisting of a match from a fingerprint reader, a match from facial recognition software, a match from iris recognition software, a match from voice recognition software or combinations thereof.

11. The method of securing a Payment Card transaction according to claim 6 wherein the mobile device decrypts the one time data code.

12. The method of securing a Payment Card transaction according to claim 1 further comprising checking if the one time data code has been used in connection with a previous transaction by the cardholder and, if it has, discarding the one time data code and generating a second one time data code.

13. The method of securing a Payment Card transaction according to claim 1 wherein the merchant comprises an ATM.

14. The method of securing a Payment Card transaction according to claim 6 wherein the mobile device is configured to function as a contactless Payment Card.
